(19) United States
(12) Patent Application Publication
(10) Pub. No.: US 2008/0015272 A1
(43) Pub. Date: Jan. 17, 2008

(54) Polyurethane Foam

(76) Inventors: Henri Mispreuve, Wangen (CH); Reinhold Naescher, Zurich (CH)

Correspondence Address: NOTARO AND MICHALOS, 100 DUTCH HILL ROAD, SUITE 110, ORANGEBURG, NY, 10962-2100, US

(21) Appl. No.: 11/569,971

(22) PCT Filed: Nov. 29, 2005
(86) PCT No.: PCT/EP05/12880

§ 371 Date: Dec. 4, 2006

(30) Foreign Application Priority Data
Jul. 1, 2005 (GB) 0513473.9
Nov. 29, 2004 (CH) 01962/04

(51) Int. Cl. C08G 18/76; C08G 18/63; C08G 18/67

(52) U.S. Cl. 521/113; 521/116; 521/170

(57) ABSTRACT

Polyurethane foam is made by reacting an isocyanate with a polyol and foam forming ingredients in the presence of a reactive double bond component, particularly an acrylate, to give a foamed body which is subjected to radical initiated cross-linking with the reactive double bond component. In one embodiment the foam-formation and cross-linking are carried out in parallel, and an organic peroxide may be included as a cross-linking initiator. In another embodiment the cross-linking is carried out after foam-formation preferably using E-beam activation. In this case different formulations, using polyether polyol with MW greater than 1500, non MDI, polymer modified polyol or non HR formulations are used. In this case also, it is also possible to use selected formulations which give at least 10% hardness increase without scorching, or which, by controlled use of 0.1 to 10 parts double bond component give low density foams with more than 4 parts water as foaming agent, without scorching.

This invention relates to polyurethane (PU) foam.

Methods for the manufacture of flexible open-celled PU foam are known in the art and are covered, for example, on pages 161-233 of the Polyurethane Handbook, edited by Dr Güenter Oertel, Hanser Publishers.

Conventionally, flexible PU foam may be made by reacting a polyol with a multifunctional isocyanate so that NCO and OH groups form urethane linkages by an addition reaction, and the polyurethane is foamed with carbon dioxide produced in situ by reaction of isocyanate with water. This conventional process may be carried out as a so-called ‘one-shot’ process whereby the polyol, isocyanate and water are mixed together so that the polyurethane is formed and foamed in the same step.
Reaction of isocyanate with polyol gives urethane linkages by an addition reaction.
   R—NCO+HO—R′→R—NH—CO—O—R′ I

Isocyanate reacts with water to give amine and carbon dioxide.
R—NCO+H₂O→RNHCOOH→RNH₂+CO₂ II

Amine reacts with isocyanate to give urea linkages.
R—NCO+RNH₂→R—NH—CO—NH—R III

Interaction of NCO, OH, H₂O will give PU chains which incorporate urea linkages as a consequence of above reactions I, II, III occurring at the same time.

Flexible PU foam typically has a segmented structure made up of long flexible polyol chains linked by polyurethane and polyurea aromatic hard segments with hydrogen bonds between polar groups such as NH and carbonyl groups of the urea and urethane linkages.

In addition, the substituted ureas (formed in III) can react with remaining isocyanate to give a biuret (IV), and the urethane can react with remaining isocyanate to give allophanates (V):

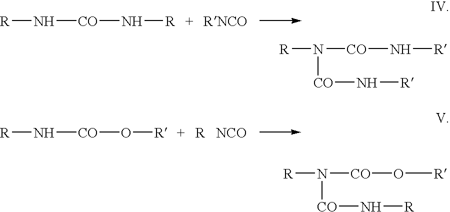

Biuret and allophanate formation results in increase in hard segments in the polymer structure and cross-linking of the polymer network.

The physical properties of the resulting foam are dependent on the structure of the polyurethane chains and the links between the chains.

For higher levels of foam hardness, and in particular to make rigid closed cell foam, polyurethane chain cross-linking is brought about e.g. by use of shorter chain polyols and/or by inclusion of high functionality isocyanates. It is also known to incorporate unsaturated compounds as radical cross-linking agents.

For many applications an open-celled PU foam which is stable and hard, i.e. has high load bearing properties, is desirable.

So called high resilience (‘HR’) PU foam, formerly referred to as cold-cure foam, is a well known category of soft PU foam and is characterised by a higher support factor and resilience compared with so-called ‘Standard’ or ‘Conventional’ foams. The choice of starting materials and formulations used to make such foams largely determine the properties of the foam, as discussed in the Polyurethane Handbook by Dr. Güenter Oertel, for example, at page 182 (1^{st} Edition), pages 198, 202 and 220 (2^{nd} Edition) and elsewhere. The starting materials or combinations of starting materials used in HR PU foam formulations may be different from those used in standard foam formulations whereby HR is considered a distinct separate technology within the field of PU foam. See page 202 table 5.3 of the above 2^{nd} Edition.

HR foam is usually defined by the combination of its physical properties and chemical architecture as well as its appearance structurally. HR foams have a more irregular and random cell structure than other polyurethane foams. One definition of HR foams for example, is via a characteristic known as the “SAG factor” which is the ratio of ‘indentation load deflection’ (ILD) at 65% deflection to that at 25% deflection (ASTM D-1564-64T). Standard foams have a SAG factor of about 1.7-2.2, while an HR foam has a factor of about 2.2-3.2. HR foam may also have characteristic differences in other physical properties. For example HR foam may be more hydrophilic and have better fatigue properties compared to standard foam. See the above mentioned handbook for reference to these and other differences.

Originally HR foam was made from ‘reactive’ polyether polyol and higher or enhanced functionality isocyanate. The polyol was typically a higher than usual molecular weight (4000 to 6000) ethylene oxide and/or propylene oxide polyether polyol having a certain level of primary hydroxyl content (say over 50% as mentioned at page 182 of the above Edition Handbook), and the isocyanate was MDI (methylene diphenyl-diisocyanate) (or mixture of MDI and TDI (toluene diisocyanate), or a prepolymer TDI) but not TDI alone (see page 220 of the above 2^{nd} Edition Handbook under Cold Cure Moulding). Subsequently (page 221) a new family of polyols, now called polymer modified polyols (also known as polymer polyols) were developed based on special polyether polyols with molecular weights of about 4000 to 5000 and with primary hydroxyl contents in excess of 70%. These together with different isocyanates, but now mainly pure TDI, were used with selected cross-linking agents, catalysts and a new class of HR silicones in the production of this new generation of HR foams.

This new family of HR foams have similar properties to those obtained using the original approach but their physical properties, including load bearing could now be varied over a wider range. The processing safety of the new foams was greatly enhanced and this enabled production of these foams using the more commercially available TDI compared to the former necessity to use mixed or trimerised isocyanates.

Polymer modified polyols contain polymeric filler material in a base polyol. The filler material may be incorporated as an inert filler material dispersed in the base polyol, or at least partially as a copolymer with the base polyol. Example filler materials are copolymerized acrylonitrile-styrene polymer polyols, the reaction product of diisocyanates and diamines (“PHD” polyols), and the polyaddition product of diisocyanates with amine alcohols (“PIPA” polyols).

Polymer modified polyols have also found use in the formulating of standard foams giving foams with higher load bearing properties.

It is well known that the reaction of relatively large quantities of water to act as an additional blowing agent for open-celled low-density foams, as described for example in U.S. Pat. No. 4,950,694, is difficult to control particularly in a large scale manufacturing context and usually leads to relatively soft foam. This can even be the case when large quantities of special polyols such as copolymerised polyols or polyols filled with polyurea are used. In addition, the use of large quantities of water to supply the blowing agent means that the isocyanate index cannot be arbitrarily raised so as to influence the hardness of the foam, since the reaction can sometimes prove too exothermic, thereby resulting in a premature, oxidative degradation of the foam material, or ‘scorched’ i.e. discoloured material.

In this respect, excessive, uncontrolled exothermic reaction must be avoided in large scale manufacturing due to the danger of ignition occurring, but also even relatively low levels of oxidative degradation can be undesirable since, in practical terms, the requirement is for ‘white’ PU foam, i.e. foam which visually, and uniformly over its cross-section, shows no browning or other discoloration and which is referred to herein as substantially discolouration-free foam. The term ‘white’ is used for convenience although in fact the foam may have a yellow coloration.

This makes itself even more noticeable when, in addition to the reactants for the polyaddition polyurethane reaction, unsaturated compounds are included with the aim of producing additional cross-linking for strengthening or increasing the stability of the polyurethane matrix. Problems are encountered in attaining stability and high load bearing properties in open-celled foams and in particular it is common practice to try to remove or minimize radicals which may promote cross-linking but which can give rise to softening and/or scorching.

With regard to the enhancement of cross-linking in the manufacture of PU material, it is known to use derivatives of acrylic acid VI which has a reactive double bond:
CH₂═CH—COOH VI

EP 262488B describes PU filler material made by reaction of hydroxyl(meth)acrylate with isocyanate using an OH to NCO ratio of about 1:1 so that the material has reactive double bonds not extractable with solvent. The resulting PU material is used in the form of a solid powder, which may be mixed with SiO₂, and can be radically cured to give a hard clear solid useful in dentistry.

EP 1129121B also describes the reaction of isocyanate with hydroxyl(meth)acrylate to give radical curable PU material with reactive double bonds not extractable with solvent. Here, the material is formed as a moulded body, rather than a powder, and the formed body is subsequently radically cured by exposure to heat and/or blue or UV light. The formed body may be produced as an air permeable foam.

U.S. Pat. No. 6,699,916A and U.S. Pat. No. 6,803,390 describe the manufacture of PU foam by reacting an isocyanate with a polyfunctional (meth)acrylate to form a prepolymer. This prepolymer would then be reacted with a polyol and foam forming ingredients. The resulting foam is a cross-linked closed cell rigid foam.

US 2004/0102538A (EP 1370597A) describes the manufacture of a flexible PU foam by reacting a polyisocyanate with polyether or polyester polyol in the presence of a (meth)acrylate polyol.

U.S. Pat. No. 4,250,005A describes the manufacture of PU foam by reacting a polyester polyol or a lower molecular weight polyether polyol (1500 or less) with an organic isocyanate and foam forming ingredients, in the presence of an acrylate cross-link promoter. The resulting foam is subjected to ionizing radiation to modify the properties of the foam.

DE 3127945 A-1 specifically describes in the given Examples the reaction of a highly reactive polyol with a mixture of TDI and MDI isocyanates in the presence of small amounts of hydroxymethacrylate compounds leading to produce foam that is subsequently treated by energy beams to modify its properties. The ingredients correspond to those which would be used to give very soft HR foam with a non-polymer modified polyol system.

In accordance with the present invention it has been found that open-celled PU foam can be manufactured with advantageous physical properties from a mixture of polyol, isocyanate and a reactive double bond component such as an acrylate by controlled radical-initiated cross-linking of the foam.

In particular it has been found possible to manufacture open-celled substantially discoloration-free foams which are stable and high load bearing.

Such foams may be elastic flexible foams such as are used for example in furniture seat cushions, or semi-rigid foams which have a flexible open-celled structure but which have sufficient rigidity to retain a shape as used, for example, as decorative structural components within motor vehicle passenger compartments, such as dashboards and the like.

It is even possible to make open-celled rigid foams, and, moreover, the invention can also advantageously be applied to the manufacture of closed cell rigid foams.

Thus, and in accordance with one aspect of the invention there is provided a method of manufacturing polyurethane foam wherein at least one multi-functional isocyanate, at least one polyol being wholly or predominantly a polyether polyol having a molecular weight greater than 1500 and foam-forming ingredients, undergo a polyaddition and foam-forming reaction in the presence of at least one reactive double bond component to produce a foamed PU body, wherein the at least one multifunctional isocyanate substantially does not comprise or include MDI, and the foamed PU body is subjected to radical-initiated cross-linking with the reactive double bond component.

The said reaction can therefore be performed substantially or wholly in the absence of MDI. A single polyether polyol may be used, or a mixture of polyether polyols. Preferably however the total polyol used, i.e. the polyol reacted with the isocyanate other than the said double bond ingredient is wholly or predominantly polyether polyol having a molecular weight or average molecular weight greater than 1500.

The foam may be of the HR kind as discussed above or may be not of the HR kind.

Thus and in accordance with a second aspect of the invention there is provided a method of manufacturing polyurethane foam wherein at least one multi-functional isocyanate, at least one polyol being wholly or predominantly a polyether polyol having a molecular weight greater than 1500 and foam-forming ingredients, undergo a polyaddition and foam-forming reaction in the presence of at least one reactive double bond component to produce a foamed PU body, wherein the foam is not HR foam and the foamed PU body is subjected to radical-initiated cross-linking with the reactive double bond component.

The polyol used in the method of the invention may comprise or include at least one polymer modified polyol as hereinbefore described whether or not the foam is formulated as an HR foam.

Thus and in accordance with a third aspect of the invention there is provided a method of manufacturing polyurethane foam wherein at least one multi-functional isocyanate, at least one polyol and foam-forming ingredients, undergo a polyaddition and foam-forming reaction in the presence of at least one reactive double bond component to produce a foamed PU body, wherein the polyol comprises or includes at least one polymer modified polyol, and the foamed PU body is subjected to radical-initiated cross-linking with the reactive double bond component.

With the second and third aspects of the invention preferably the isocyanate substantially does not comprise or include MDI, as with the first aspect of the invention.

Surprisingly the method of the invention can result in a stable PU foam having excellent physical properties, without scorch problems necessarily arising.

This is a consequence of the application of the radical-initiated cross-linking step applied to the specific three component polyol, isocyanate, reactive double bond component) PU foam system.

Without intending to be restricted to any particular mechanism, it is believed that the presence of the reactive double bond component in a radical-initiated environment can give cross-linking with carbon to carbon double bonds, as opposed to polar cross-linking such as to enable a desired compression hardness to be attained whilst moderating free radical availability and thereby reducing risk of scorching or discolouration caused by exothermic reaction. The double bond component can act to moderate free radical activity e.g. by reacting with radical initiating substances, such as peroxides, which may be substances specifically added for initiation purposes or which may be substances naturally present in small amounts e.g. in raw material polyol. The quantity requirements for the double bond component for protective reaction with initiator will correspondingly vary.

That is, using particular ‘basic’ PU foam-forming components, (i.e. the isocyanates, polyol and the foam-foaming ingredients), the addition of the double bond component and the application of the radical initiation step enable production, even in a large scale manufacturing context, of an acceptable ‘white’ PU foam which may be harder than would be the case using essentially the same basic components alone (i.e. without the double bond component and the radical initiation step).

The increase in hardness may be of the order of at least 10% as discussed further hereinafter. The actual hardness will depend on requirements and will be determined by the basic components used and other parameters.

As mentioned above, hardness can be increased in conventional PU foam system by increasing isocyanate index (stoichiometric excess over that required by the polyol) but this gives increased risk of scorching. With the present invention hardness can be increased without requiring similar increases in isocyanate index whereby scorching can be more readily moderated or avoided.

By way of example only, a stable open-celled PU foam having a compression hardness of at least 5 kPa is readily attainable even at low densities i.e. 20 to 25 kg/m³ or less.

Thus, and in accordance with a fourth aspect of the invention there is provided a method of manufacturing polyurethane foam wherein basic components comprising at least one multi-functional isocyanate, at least one polyol and foam-forming ingredients, undergo a polyaddition and foam-forming reaction in the presence of at least one reactive double bond component to produce a stable open-celled substantially discoloration-free foamed PU body, characterised in that the open-celled substantially discoloration-free foamed PU body is subjected to radical-initiated cross-linking with the reactive double bond component to give, a compression hardness of at least 10% greater than the comparable hardness of the stable open celled substantially discoloration-free foamed PU foamed using comparable said basic components without addition of the said double bond component. By comparable said basic components is meant essentially the same basic components i.e. the same polyol, isocyanate and principal foam-forming ingredients, but allowing for any variations in catalysts or other additives to accommodate absence of the double bond component.

The double bond component can generally have an unexpected advantageous affect, even when used at relatively low levels, in that it can prevent scorch when relatively high levels of water are used for foam formation to give lower density foam. When higher levels of water are used substantially without volatile foaming ingredient (which evaporates rather than reacting with the isocyanate and has a cooling affect) scorching is generally a serious problem.

Accordingly, and especially in the production of low density foam, say less than 25 kg/m³, particularly less than 22 or 20 kg/m³, in the various above mentioned aspects of the invention with a water ingredient content greater than 4 parts and substantially no volatile foaming ingredient, the double bond component may be used at 0.1-10 parts preferably 0.1-5 parts particularly approximately 3 parts, to give low density foam having good properties substantially without scorching. All parts are with reference to 100 parts by weight polyol.

Thus, and in accordance with a fifth aspect of the invention there is provided a method of manufacturing polyurethane foam wherein basic components comprising at least one multi-functional isocyanate, at least one polyol and foam-forming ingredients including water but substantially in the absence of any volatile foam forming ingredient, undergo a polyaddition and foam-forming reaction in the presence of at least one reactive double bond component to produce a stable open-celled substantially discoloration-free foamed PU body, characterised in that the open-celled substantially discolouration free foamed PU body is subjected to radical-initiated cross linking of the reactive double bond component, and wherein the double bond component is used at 0.1 to 10 parts, preferably 0.1-5 parts, particularly approximately 3 parts, and the water is used at greater than 4 parts.

The fourth and fifth aspects of the invention may be combined with any or all of the features of the preceding aspects of the invention and thus may or may not use MDI, polyether polyol of MW greater than 1500, polymer modified polyol, and may or may not be HR foam as appropriate. Preferably MDI is not used.

Preferably the polymer modified polyol has a base polyol which is wholly or predominantly a polyether polyol. Preferably also the isocyanate does not substantially comprise or include MDI.

In one embodiment the radical initiated cross-linking is applied subsequent to the said polyaddition and foam-forming reactions, which may be at any convenient time, or on any convenient occasion after the formation of the foamed PU body.

In another embodiment the radical-initiated cross-linking occurs in parallel with the said polyaddition and foam-forming reactions.

Thus, and in accordance with a sixth aspect of the present invention there is provided a method of manufacturing a polyurethane foam wherein at least one multi-functional polyisocyanate, at least one polyol and foam-forming ingredients, undergo a polyaddition and foam-forming reaction in the presence of a reactive double bond component to produce a foamed PU body, characterised in that the PU body is subjected to radical-initiated cross-linking with the reactive double bond component which occurs in a parallel with the said polyaddition and foam-forming reactions. This aspect of the invention may be combined with features of foregoing aspects of the invention as appropriate. Thus for example the polyol may comprise a polyether polyol and may be used in a polymer modified polyol non MDI high resilience system. However, other ingredients, formulations and systems, including for example, non HR polyester polyol systems can also be used.

In any of the above aspects of the invention the radical initiated cross-linking may be applied in the presence of a radical initiator, which may be a peroxide. This is particularly useful in the case where radical initiated cross-linking occurs in parallel as mentioned above. However, it is also possible to incorporate a radical initiator in the case where cross-linking is to be initiated subsequently in so far as it has been found possible to retain stability and defer radical-initiated cross-linking despite the presence of the initiator during the polyaddition and foam-forming process.

Thus, and in accordance with a seventh aspect of the invention there is provided a method of manufacturing a polyurethane foam wherein at least one multi-functional polyisocyanate, at least one polyol and foam-forming ingredients, undergo a polyaddition and foam-forming reaction in the presence of a reactive double bond component to produce a foamed PU body, characterised in that the PU body is subjected to radical-initiated cross-linking with the reactive double bond component, in the presence of a radical initiator. This aspect of the invention may be combined with features of foregoing aspects of the invention as appropriate. Thus for example the polyol may comprise a polyether polyol and may be used in a polymer modified polyol non MDI high resilience system. However, other ingredients, formulations and systems, including for example, non HR polyester polyol systems can also be used.

With regard to the radical initiation step of all of the above aspects of the invention, this is carried out such as to cause the double bond component to be modified so as to enhance or enable the reactivity of the (or each) double bond to effect cross-linking within the foamed PU body.

This may be achieved as a consequence of the action on the double bond by the radical initiator and/or by application of disruptive or modifying energy.

Such energy may consist of any one or more of: heat, ionizing radiation in visible or near-visible spectral ranges (such as UV), higher energy ionizing radiation.

In a particular preferred embodiment higher energy ionizing radiation is used alone, or in combination with heat and/or in the presence of a radical initiator. Such radiation is known in the art and may constitute any suitable particulate or wave form of ionizing radiation. Reference is made to U.S. Pat. No. 4,250,005 for a description of suitable such radiation, e.g. gamma radiation. A particularly preferred radiation is electron beam (E-beam) radiation. E-beam radiation constitutes high-energy electrons generated by a powerful beam accelerator. The electrons impact molecules and bring about a shift to a higher-energy molecular state which initiates and sustains cross-linking which can result in an otherwise unobtainable level of mechanical properties.

Preferably the basic PU components (as hereinbefore defined) are used in a concentration and/or quantity which produce an exothermy sufficient for radical formation and at the same time a controlled, antioxidative anti scorch effect of the double bond component(s).

In order to control the intensity of the reaction and/or the speed and/or of the extent of the radical cross-linking, the concentration of the component(s) having the reactive double bonds may be varied, that is to say specifically adjusted or set with a view to the intended control function.

In order to control the hardness and/or load-bearing capacity of the foam produced, the concentration of the component(s) having the reactive double bonds may be varied, that is to say specifically adjusted or set with a view to the intended control function.

In order to prevent the oxidative degradation of the foam produced, the concentration of the component(s) having the reactive double bonds may be varied, that is to say specifically adjusted or set with a view to the intended protective function.

Where at least one radical-forming agent, which may be an organic peroxide, is also added to the mixture of basic components, as mentioned above, the concentration of the component(s) having the reactive double bonds may be adjusted to the concentration of the radical-forming agent added, and/or at least one radical-trapping substance, in particular at least one antioxidant, may be added to the mixture of basic components.

The invention of the foregoing aspects may be performed using the following components, proportions being in php (parts per hundred parts by weight) related to total polymer content (i.e. a)+b) as follows):
a) up to 99 particularly up to 95 or 97 php polyether and/or polyester polyols with OH-groups having a functionality of at least 2 preferably 2 to 5;
b) up to 99 (particularly from 0.1 or 1, preferably from 3) php of one or more polymers having reactive double bonds, particularly acrylate or methacrylate-based polymers as described hereinafter;
c) isocyanate having an NCO functionality of at least 2 preferably 2 to 5;
d) 0.5 to 20, in particular 2 to 12 php water as blowing agent;
e) where necessary, 0.05 to 5 php of at least one radical initiator or radical-forming agent, preferably an organic peroxide;
f) any catalysts; and
g) any other auxiliary agents

The quantities of isocyanate and water are adjusted to one another and are typically selected so as to result in a calculated OH:NCO index of 50-130, preferably 70-120 and in particular 85-120, an index of 100 indicating a stoichiometric ratio of OH and NCO groups, an index of 90 a shortfall and an index of 110 an excess of NCO groups in relation to the OH groups (index=percentage saturation of the OH groups by NCO groups).

Preferably the mixture of components contains polymers with reactive double bonds containing hydroxyl groups, in particular acrylate or methacrylate polymers containing hydroxyl groups although other groups reactive to isocyanate such as amine groups may be present additionally or alternatively to hydroxyl groups. Thus, in addition to acting as radical cross-linking agents which form carbon to carbon bonds with polyurethane chains due to reaction with the double bonds, such components also react with isocyanate groups to form polymeric chains therewith through urethane and/or other linkages.

By using a double bond component which is capable of reacting with isocyanates, such components can become incorporated within the polyurethane matrix as the foam PU body is formed. The double bond component is thereby retained as an active non-fugative anti-scorch additive.

The method of the invention may be performed using prepolymer i.e. polymeric material made in a first step by reacting polyol and/or a reactive double bond component with a multi-functional isocyanate (which may be the same as or different from the isocyanate used in the foam-forming reaction) to give a hydroxyl or isocyanate terminated prepolymer which in a second step is reacted with further polyol and/or a reactive double bond component and/or multifunctional isocyanate. The steps may use the same or different polyol, reactive double bond component and multifunctional isocyanate for these two steps. In particular, any combination of above mentioned components a) and b) may be pre-reacted with the isocyanate of c). The use of prepolymers is well known in the polyurethane art to facilitate polyurethane foam production and/or to modify the foam properties.

Also, the polyol used may comprise polymer modified polyol such as is known in the manufacture of HR foams (so called, ‘high resilience’ or ‘high comfort’ foams as discussed above). These polyols are modified by chemical or physical inclusion of additional polymeric substances. The present invention permits formulation of HR foams with increased hardness.

In a further embodiment the above mentioned organic peroxide has a half-life ranging from approx. 15 minutes to approx. 5 seconds within a temperature range of 120-250° C.

The organic peroxide may be selected from the group consisting of hydroperoxides, dialkylperoxides, diacylperoxides, peracids, ketoneperoxides and epidioxides. Dialkyl peroxide such as Trigonox 101 (trademark of AKZO Nobel) or Peroxan HX (trademark of Pergan) i.e. 2,5 dimethyl-2,5-di (tert-butylperoxy) hexane, or dicumyl peroxide (Peroxan DC) is especially suitable due to their relatively high temperature stability.

Carbon dioxide liquid or gas (or other materials) may be used as additional blowing agent.

In a further embodiment the foaming may be performed at pressures less than or greater than atmospheric pressure.

In a further embodiment the components are fed individually, mixed in a mixer or mixing head and then foamed, preferably with simultaneous forming.

The invention relates in particular to a method, which is suitable for the manufacture of PU foams on an industrial scale, in particular for the industrial manufacture of PU foam slab stocks.

With the invention it is possible to produce a single-end, stabilised, cross-linked polyurethane foam, which, for a given density and cell count, has at least 10%, preferably at least 15% greater hardness and/or load-bearing capacity than conventional foams of identical or comparable formulation as hereinbefore discussed.

By way of example, the invention can provide a PU foam, which has at least one of the following characteristics:
a gross density of 5 to 120 kg/m3;
a cell count of 10 to 120 ppi;
a compression hardness of at least 5 kPa, preferably at least 15 kPa and in particular at least 20 kPa, measured according to EN ISO 3386-1 at 40% deformation;
a possible increase in hardness of at least 10% relative to equivalent formulations not in accordance with the invention.
alternatively or additionally low density foam, made with high water content, which does not scorch
wholly or predominantly open cells.

It is also possible with the method according to the invention, however, to manufacture closed-cell foams.

PU foam according to the invention can be used for example as composite material, for packaging applications, for thermal and/or sound insulation, for the manufacture of displays, filters, seating and beds, for many different industrial applications and/or transport purposes, in particular for applications in the motor vehicle sector and in building and construction.

The PU foams manufactured according to the invention are typically flexible foams; with the method according to the invention, however, it is also possible to manufacture rigid foams.

With one aspect of the present invention this results in a new class of PU foams resulting from two cross-linking reactions which run separately but take place simultaneously in parallel. One of the reactions, the polyaddition reaction (polyurethane reaction), is based on the conventional chemistry of polyurethanes, the second reaction is based on a radical-induced cross-linking of double bonds. These two reactions take place in one operation during the expansion of the foam and typically result in a characteristic profile which is distinguished by significantly increased hardness and load-bearing capacity compared to such foams that have been manufactured according to an identical or at least comparable formulation, but in a conventional sequential sequence of polyurethane and radical cross-linking.

The simultaneous occurrence of the two chemical reactions is contrary to conventional teaching, since a premature, oxidative degradation of the foam would be assumed. Phenomena such as unstable colours, impairment of the mechanical characteristics and possible spontaneous ignition due to high exothermy would be anticipated (see, for example, section 3.4.8, page 104, and section 5.1.1.3, page 169 of Polyurethane Handbook, edited by Dr Güenter Oertel, Hanser Publishers).

With the present invention, however, it has surprisingly proved possible to purposely control and curb these phenomena, which owing to the law of mass action and the heat transfer phenomenon only play an important role beyond the laboratory scale, that is to say only on an increasingly larger scale, particularly on a large industrial scale and more especially in the industrial manufacture of foam slab stock. In facilitation of this additional fractions of the same or of an other double bond component, and any additional or alternative antioxidants which usefully serve to chemically bind and/or neutralise or render harmless the radicals produced during the reaction, before the onset of their degrading effect, as necessary can be included as additives with the basic components: polyol, isocyanate and the double bond component.

This procedure not only makes it possible to make deliberate and controlled use of any radicals that might already be spontaneously produced in the course of the exothermic polyurethane reaction for the purpose of radical cross-linking, but also allows additional radical-forming agents, such as organic peroxides, to be used for speeding up the reaction and/or for the purpose of more intensive radical cross-linking, without in the process jeopardising the entire foam forming system. By adjusting the reaction components to one another, in particular the concentration of the double bond component in relation to the isocyanate and the polyol, and any additional radical-forming agents and/or radical-trapping substances or antioxidants, it is possible not only to successfully overcome the aforementioned disadvantages and the prejudices of the prior art, but also in particular to produce a new generation of so-called “high-load bearing” foams. The distinguishing features of this new generation of foams are a different three-dimensional structure compared to sequential cross-linking and at least 10%, preferably at least 15% and often even more than 20% greater hardness and/or load-bearing capacity than conventional foams of the same or a comparable formulation (as discussed above).

In addition, the method according to the invention is not only suited to manufacturing lower-density PU foams more easily, rapidly and inexpensively than by means of conventional methods, but also to producing semi-rigid to rigid grades of foam much more efficiently. As stated, this also makes it possible, for a given density, to produce significantly more rigid or high load bearing foams than have hitherto been described in the technical literature.

The key factors for this new generation of PU foams are, in particular:
the use of raw materials of selected, suitable functionality and reactivity for the manufacture of PU foam,
the use of raw materials, the molecules of which have reactive double bonds, and
any radical-generating and/or radical-trapping additives, in particular antioxidative additives.

Either through a sufficiently high exothermy of the polyurethane reaction and/or through the activity of further added or activated in-situ radical-forming substances they give rise to the production of radicals and hence to a cross-linking through radically induced double bond reactions running in parallel with the polyurethane reaction.

Where necessary or advantageous, the method according to the invention can be speeded up or the radical cross-linking can be intensified by the addition of radical-generating substances (“radical-forming agents”) to the mixture of basic components, in particular by the addition of peroxides. Suitable peroxides, for example, are those having a decomposition temperature and reactivity suited to the manufacture of PU foam. Other suitable peroxides, however, include those in which decomposition cannot be induced solely or even at all by thermal means or other application of energy, but also by the influence of chemical substances, such as catalyst promoters, amines, metal ions, strong acids and bases, strongly reducing or oxidising substances, or even by contact with certain metals. Organic peroxides, which at reaction temperatures in the range of approx. 130-180° break down sufficiently rapidly to permit a foaming time of approx. 2 to 5 minutes, are especially preferred. Typical half-lives of suitable organic peroxides therefore range from a few seconds, for example 5 seconds, at 180° C., up to a few minutes, for example 10-15 minutes, at 130° C. Such peroxides are familiar to those skilled in the art and are commercially available. In addition to the peroxides, so-called peroxide-coagents may also be used, such as those commercially available under the name Saret®-coagents (Sartomer Company).

The double bond component used in the present invention acts to improve hardness through cross-linking whilst moderating radical formation to prevent unacceptable discoloration, as discussed above.

As explained, this cross-linking with the double bond component may be essentially initiated either in parallel with foam formation or subsequently and this may be caused by application of heat or ionizing radiation alone or in the presence of an active radical initiator such as a peroxide.

Where a radical initiator is used this may be immediately effective or it may be dormant and may only become active when it is subjected to activating heat which may be derived from exothermic reaction of the foam polyurethane-forming components.

Generally, higher energy ionizing radiation will be used as an alternative to a heat-activated radical initiator, although the possibility of using ionizing radiation additionally to a radical initiator, which may or may not be heat activated, is not excluded.

Whichever procedure is adopted, advantageous foam material is produced as a consequence of the cross-linking and moderating action of the double bond component, the radical initiator and the ionizing radiation providing alternative means of initiating cross-linking in a controlled manner.

As mentioned, where used, the ionizing radiation may be e-beam radiation which, in accordance with conventional practice, would preferably be applied in fixed, predetermined energy doses.

In addition to the aforementioned method for the manufacture of PU foams using basic substances such as polyol methacrylates and mixtures of polyol methacrylates with polyether and/or polyester polyols, the invention also relates to the PU foams manufactured thereby. These relate, for example, but are in no way confined to semi-rigid to rigid PU foams, which in addition to the increase in hardness and/or load-bearing capacity are also additionally distinguished by virtue of the following characteristics:
gross density of 5 to 120 kg/m3
compression hardness of at least 5 kPa, preferably at least 15 kPA and in particular at least 20 kPa, at 40% compression
cell counts of 10 to 120 ppi (ppi=pores per inch)

These characteristics can be readily obtained by the foaming of polyol methacrylates or mixtures of polyol methacrylates with polyols (ether and/or ester).

The aforementioned properties of the new generation of PU foams such as great hardness, high load-bearing capacity and/or high compression hardness/density ratio, are achieved by new formulations based on a combination of
a) polyols, preferably ether and/or ester-based (which includes polymer modified polyols);
b) compounds containing reactive double bonds, particularly methacrylate and/or acrylate polymers;
c) aliphatic or aromatic polyisocyanates;
d) water as blowing agent;
e) any radical-releasing substances, for example organic peroxide;
f) catalysts; and
g) any further additives.
   Possible and preferred proportions by weight are discussed hereinbefore.

Polyols are preferably likewise used as group (b) components, although in contrast to (a) these must contain reactive double bonds. In addition to the components (a) to (e), the new formulations may contain further additives (f), (g) in the form of radical trapping agents, such as antioxidants, peroxide-coagents and/or all usual additives for the manufacture of PU foams, such as expansions agents, catalysts, stabilisers, pigments, etc.

Polyether and/or polyester polyols containing hydroxyl groups with a hydroxyl functionality of at least 2, preferably of 2 to 5 and a molecular weight ranging from 400 to 9000 can be used as group (a) basic component, although as discussed above polyether polyols are preferably or in some cases necessarily used exclusively or predominant, particularly at molecular weights over 1500.

Use is preferably made of those polyols which are commonly known for the manufacture of PU foams. Suitable polyether polyols, including polymer modified polyols are described, for example on pages 44-53 and 74-76 (filled polyols) of the Polyurethane Handbook, edited by Dr Güenter Oertel, Hanser Publishers.

Polyether polyols, which contain additionally built-in catalysts, may also be used. Mixtures of the aforementioned polyether polyols with polyester polyols can furthermore be used. Suitable polyester polyols, for example, are those described on pages 54-60 of Polyurethane Handbook, edited by Dr Güenter Oertel, Hanser Publishers.

Prepolymers from the aforementioned polyol components may equally well be used.

Polyisocyanates containing two or more isocyanate groups are used as group (c) components. Standard commercial di- and/or triisocyanates are typically used. Examples of suitable ones are aliphatic, cycloaliphatic, arylaliphatic and/or aromatic isocyanates, such as the commercially available mixtures of 2,4- and 2,6-isomers of diisocyanatotoluene (=tolylenediisocyanate TDI), which are marketed under the trade names Caradate® T80 (Shell) or Voronate® T80 and T65 (Dow Chemical). 4,4′-diisocyanatodiphenylmethane (=4,4′-methylenebis(phenylisocyanate) (MDI); and mixtures of TDI and MDI can also be used where the context permits. It is also possible, however to use isocyanate prepolymers based on TDI or MDI and polyols. Modified isocyanates (for example Desmodur® MT58 from Bayer) may also be used. Examples of aliphatic isocyanates are 1,6-hexamethylene diisocyanates or triisocyanates such as Desmodur® N100 or N3300 from Bayer.

Polymers containing double bonds (DB) with a double bond content of 2 to 4 DB/mol, a molecular weight range of 400 to 10′000, and preferably a hydroxyl functionality of 2 to 5 are typically used as group (b) components. Instead of or in addition to such polymers, however, it is also possible to use functional monomers with reactive double bonds either individually or in a mixture of two or more monomers, for example acrylate and/or methacrylate monomers, acrylamide, acrylonitrile, maleic anhydride, styrene, divinylbenzene, vinyl pyridine, vinyl silane, vinyl ester, vinyl ether, butadiene, dimethylbutadiene, etc., to name but a few examples.

All hydroxy (meth)acrylate oligomers from OH functionality above 2 and OH number from 5 to 350 can be used. Classes of products include: Aliphatic or aromatic epoxy diacrylates, polyester acrylates, oligoether acrylates. Key parameters are viscosity in order to be processable in PU, reactivity. Preferred are methacrylates but acrylates have been shown to work as well.

Additional examples of hydroxyl-functional (meth)acrylates are: bis(methacryloxy-2-hydroxypropyl) sebacate, bis(methacryloxy-2-hydroxypropyl) adipate, bis(methacryloxy-2-hydroxypropyl) succinate, bis-GMA (bisphenol A-glycidyl methacrylate), hydroxyethyl methacrylate (HEMA), polyethylene glycol methacrylate, 2-hydroxy and 2,3-dihydroxypropyl methacrylate, and pentaerythritol triacrylate.

One suitable substance is Laromer LR8800 which is a polyester acrylate with a molecular weight around 900, double bond functionality around 3,5, OH number of 80 mg KOH/gram and a viscosity of 6000 mPa·s @ 23° C.

Another substance is Laromer LR9007 which is a polyether acrylate with a molecular weight around 600, Double bond functionality around 4.0, OH number of 130 mg KOH/gram and a viscosity of 1000 mPa·s @ 23° C.

Polyether and/or polyester polyols, in particular those on an acrylate basis, are preferably also used for this. Polyether and polyester acrylates are commercially available, for example, under the names Photomer® (Cognis Corp.) and Laromer® (BASF). Other useable polymers are known, for example. as Sartomer® (Total Fina).

Where necessary or desirable, commercially available organic peroxides, for example, are used as group (e) reaction components. Peroxides are preferred which are stable and slow to react below the reaction temperature which results from the exothermy of the polyurethane reaction, that is to say ones which have the longest possible half-life and which rapidly disproportionate and exercise their radical-forming function only in excess of a temperature in the exothermic temperature range of the PU polyaddition reaction. This synchronisation permits and ensures the fullest possible initial cross-linking (polyaddition reaction) and a rapidly occurring, radically initiated and catalysed cross-linking of the reactive double bonds for the end product. In the exothermic temperature range from approx. 120 to 180° C., suitable peroxides have a half-life of a few seconds to a few minutes, for example 5 seconds at 180° C. to 15 minutes at 120° C.

As group (g) components, peroxide coagents (for example Saret® products), radical-trapping substances such as unsaturated, in particular aromatic, organic compounds and/or antioxidants, such as Fe(II) salts, hydrogen sulphite solution, sodium metal, triphenylphosphine and the like, can be added to the mixture of basic components for purposely controlling the radical cross-linking.

Where necessary or advantageous, catalysts for the isocyanate addition reaction, in particular tin compounds such as stannous dioctoate or dibutyltin dilaurate, but also tertiary amines such as 1,4-diazo(2,2,2)bicyclooctane may be used as group (f) additives. It is also possible at the same time to use various catalysts.

Further examples of group (g) additives that may be used are auxiliary agents such as chain extenders, cross-linking agents, chain terminators, fillers and/or pigments.

Examples of suitable chain extenders are low-molecular, isocyanate-reactive, difunctional substances such as diethanolamine and water.

Low-molecular, isocyanate-reactive tri or higher functional substances such as triethanolamine, glycerine and sorbitol can be used as cross-linking agents.

Suitable chain terminators are isocyanate-reactive, monofunctional substances, such as monohydric alcohols, primary and secondary amines.

Organic or inorganic solids such as calcium carbonate, melamine or nanofillers may be used as fillers.

Examples of further auxiliary agents which may be added are flame retardants and/or pigments.

Foaming can be carried out using conventional plastics technology facilities such as are described, for example, on pages 162-171 of Polyurethane Handbook, edited by Dr Güenter Oertel, Hanser Publishers., for example using a foam slab stock unit.

The example formulations and ingredients discussed above may be used in any or all of the aforedescribed aspects of the invention as appropriate.

The invention will now be described further in the following examples.

### EXAMPLE 1

### Foaming According to the Invention Compared to a Conventional Method with Formulation According to the Prior Art

The manufacture of the foams according to the formulations in Table 1 was done by handmix in the laboratory based on 500 gms polyol. The formulation of the components taking part in the reaction was identical in both cases except for the addition of radical forming agents where indicated.

TABLE 1

| | | | Reference formulation according to the | | |
|---|---|---|---|---|---|
| Formulation according to the invention | | | prior art with polyether polyol | | |
| 25 | php | Laromer LR 8800 | 25 | php | Laromer LR 8800 |
| | | (hydroxl No. 80, | | | (hydroxl No. 80, |
| | | 3.5 DB/mol, ester acrylate) | | | 3.5 DB/mol, ester acrylate) |
| 75 | php | Desmophen 3223 | 75 | php | Desmophen 3223 |
| | | (hydroxl No. 35, polyether | | | (polyether polyol with |
| | | polyol) | | | hydroxl No. 35) |
| 54.3 | php | TDI 80 | 55 | | TDI 80 |
| | | (diisocyanatotoluene, | | | (diisocyanatotoluene, |
| | | mixture of 2,4 - and 2,6 | | | mixture of 2,4 - and 2,6 |
| | | isomers in a ratio of 80:20) | | | isomers in a ratio of 80:20) |
| 5.0 | php | Water | 5.0 | php | Water |
| 1.0 | php | 1,1-di(tert-butylperoxy)- | / | | / |
| | | 3,3,5-trimethylcyclohexane | | | |
| | | t½ 13 min at 128° C. | | | |
| 0.1 | php | Niax A - 1 | 0.2 | php | Niax A - 1 |
| 0.27 | php | Stannous octoate | 0.23 | php | Stannous octoate |
| 0.8 | php | Stabilizer | 0.8 | php | Stabilizer |

Foam result

| | | | |
|---|---|---|---|
| gross density (kg/m3) | 17 | gross density (kg/m3) | 23 |
| compression hardness | 20 | compression hardness | 5.9 |
| (kPa) | | (kPa) | |
| cell count (ppi) | 51 | cell count (ppi) | 53 |

Test Methods:
Measurement of the compression hardness according to EN ISO 3386-1 at 40% deformation.
The cell structure is determined by counting the number of cells situated on a straight line. Data are expressed in ppi (pores per inches).

As can be seen from Table 1, the method according to the invention results in a PU foam product which for a comparable cell count has an approximately 25% lower density but a compression hardness more than three times greater than a PU foam manufactured according to a comparable formulation by a conventional method.

### EXAMPLE 2

### Anti-Oxidative Effect of the Double Bond Components

TABLE 2

| Formulation according to the invention | | | Prior art | | |
|---|---|---|---|---|---|
| 3 | php | Laromer LR 8800 | / | | / |
| | | (acrylic ester with hydroxyl | | | |
| | | No. 80, 3.5 DB/mol) | | | |
| 97 | php | Desmophen 3223 (polyether | 100 | php | Desmophen 3223 (polyether |
| | | polyol with hydroxyl No. 35) | | | polyol with hydroxl No. 35 |
| 65.6 | php | TDI 80 (diisocyanatotoluene, | 65 | php | TDI 80 (diisocyanatotoluene, |
| | | mixture of 2,4 - and 2,6 - | | | mixture of 2,4 - and 2,6 - |
| | | isomers in a ratio of 80:20) | | | isomers in a ratio of 80:20) |
| 6.0 | php | Water | 6.0 | php | Water |
| 0.1 | php | Niax A - 1 | 0.12 | php | Niax A - 1 |
| 0.23 | php | Stannous octoate | 0.23 | php | Stannous octoate |
| 0.8 | php | Stabilizer | 0.8 | php | Stabilizer |
| 1 | php | Methylene chloride | 1 | php | Methylene chloride |

WITHOUT MICROWAVE

| | | | |
|---|---|---|---|
| gross density (kg/m3) | 21 | gross density (kg/m3) | 21.3 |
| L*/a*/b* | 84.72/−0.25/−0.54 | L*/a*/b* | 86.73/−0.39/−0.78 |
| Characteristic | White | Characteristic | White |
| foam colour | | foam colour | |

WITH MICROWAVE
(40 sec at 800 W after 1 minute foam mixing

| | | | |
|---|---|---|---|
| gross density (kg/m3) | 16.5 | gross density (kg/m3) | 19 |
| L*/a*/b* | 84.35/−1.89/8.91 | L*/a*/b* | 64.01/9.28/31.55 |
| Characteristic | Light yellow, | Characteristic | Dark brown, |
| foam colour | foam stable | foam colour | foam crumbled |
| Delta E | 9.6 | Delta E | 40.68 |

Test Conditions:
formulation based on 50 grams polyol;
mix all components for 30 sec, except stannous octoate and TDI;
introduce stannous octoate, mix for 5 sec;
introduce TDI, mix for 5 sec;
allow mixture to react and swell in a polypropylene box for one minute;
heat mixture at 800 W for 40 sec in microwave oven (Panasonic NN-E222M, 20 litre);
allow to react for at least 2 hours;
cut foam slab into two and test the core area, in particular, manually for mechanical quality, and
measure Delta E, L*,a*,b* using Microflash colour analyzer

(Datacolor International).

The heating by means of a microwave simulates on a laboratory scale the exothermy of the foaming reaction otherwise occurring on an industrial scale. The results verify quite impressively the protective effect, according to the invention, of the double bond components in this example of Laromer® LR 8800.

Tables 3A-G:

An explanation of the substances used is given at the end of the tables.

Where indicated, e-beam activation is used after formation of the foamed PU body using controlled e-beam doses.

The amount of energy (radiation) applied to the foams is expressed as absorbed dose. The energy absorbed by unit weight of product is measured in Gray (Gy). The typical dose in the examples is 50 kGy (equivalent to 50 kJ/kg). However effect on Hardness is seen in a wide range of energy absorbed (from 2 to 80+mGy). E-beam curing was made on an installation with a 10 MeV (Mega electron Volt) LC energy source manufactured by IBA SA (Belgium).

TABLE 3A
(Corresponds to Table 1)

| | A | B |
|---|---|---|
| Laromer LR 8800 (oh = 80) | 25 | 25 |
| Desmophen 3223 (oh = 35) | 75 | 75 |
| TDI(80/20) | 55 | 54.3 |
| Iso Index | 95 | 95 |
| Water | 5 | 5 |
| Peroxan PK295V-90 | 0 | 1 |
| Niax A1 | 0.2 | 0.2 |
| DMEA | | |
| Stannous Octoate | 0.23 | 0.23 |
| Silicone surfactant | 0.7 | 0.8 |
| Density Kg/m3 | 23 | 17 |
| Compression Hardness Kpa | 5.9 | 20 |
| (No precycle) | | |
| Compression Hardness Kpa | ND | ND |
| (ENISO 3386-1) | | |
| Cell count | 53 | 51 |

ND: not determined

TABLE 3B

| | C | D | E | F |
|---|---|---|---|---|
| | php | php | php | php |
| Laromer LR 8800 | | 25 | 25 | 25 |
| (oh = 80) | | | | |
| Desmophen 3223 | 100 | 75 | 75 | 75 |
| (oh = 35) | | | | |
| TDI (80/20) | 53 | 54.8 | 54.8 | 54.8 |
| Iso Index | 105 | 105 | 105 | 105 |
| Water | 4.5 | 4.5 | 4.5 | 4.5 |
| Peroxan PK295V-90 | nil | nil | nil | 1 |
| Niax A1 | 0.2 | 0.2 | 0.2 | 0.2 |
| Stannous Octoate | 0.21 | 0.21 | 0.21 | 0.21 |
| Silicone | 0.6 | 0.6 | 0.6 | 0.6 |
| surfactant | | | | |
| Properties | | | | |
| Density Kg/m3 | 22.1 | 22.8 | 22.8 | 23 |
| Compression | 8.2 | 10.3 | 12 | 26.8 |
| Hardness Kpa | | | | |
| (No precycle) | | | | |
| Compression | 4.5 | 4.72 | 6 | 10.8 |
| Hardness Kpa | | | | |
| (ENISO 3386-1) | | | | |
| Comments | Standard | Standard | Standard | Peroxide |
| | W/O | With | With | Activated |
| | Acrylate | Acrylate | Acrylate | in Situ |
| | | No activation | E-beam | Activation |
| | | | Activated | |

TABLE 3C

| | G | H | I | J | K | L | M | N | O | P |
|---|---|---|---|---|---|---|---|---|---|---|
| | php | php | php | php | Php | php | Php | php | php | php |
| Laromer LR 8800 | 0 | | | 25 | 25 | 25 | 25 | 25 | 25 | 25 |
| (oh = 80) | | | | | | | | | | |
| Desmophen 3223 | | 25 | 25 | | | | | | | |
| (oh = 35) | | | | | | | | | | |
| Lupranol 4700 | 100 | 75 | 75 | 75 | 75 | 75 | 75 | 75 | 75 | 75 |
| (oh = 28) | | | | | | | | | | |
| TDI (65/35) | 20 | 20 | 20 | 22.1 | 22.1 | 22.1 | 22.1 | 22.1 | 22.1 | 22.1 |
| TDI (80/20) | | | | | | | | | | |
| Iso Index | 105 | 105 | 105 | 105 | 105 | 105 | 105 | 105 | 105 | 105 |
| Water | 1.45 | 1.45 | 1.45 | 1.45 | 1.45 | 1.45 | 1.45 | 1.45 | 1.45 | 1.45 |
| Peroxan DC | | | | | | | | 3 | 3 | 3 |
| Peroxan BHP70 | | | | | | 1 | | | | |
| DMEA | 0.06 | 0.06 | 0.06 | 0.06 | 0.06 | 0.06 | 0.06 | 0.06 | 0.06 | 0.06 |
| Stannous Octoate | 0.23 | 0.23 | 0.23 | 0.23 | 0.23 | 0.23 | 0.23 | 0.23 | 0.23 | 0.23 |
| Urea | 0.45 | 0.45 | 0.45 | 0.45 | 0.45 | 0.45 | 0.45 | 0.45 | 0.45 | 0.45 |
| Silicone | 0.6 | 0.6 | 0.6 | 0.6 | 0.6 | 0.6 | 0.6 | 0.6 | 0.6 | 0.6 |
| Surfactant | | | | | | | | | | |
| Density Kg/M3 | 58.9 | 59.7 | 59.7 | 53.1 | 53.1 | 60.7 | 53.1 | 55.2 | 55.3 | 55.3 |
| Compression | 33 | 22.1 | 21.74 | 22.6 | 24.58 | 63.3 | 35 | 22.4 | 50 | 40 |
| Hardness (Kpa) | | | | | | | | | | |
| (No precycle) | | | | | | | 18.9 | | | 24.5 |
| | | | 20 min. | | 20 min/180 C. | | | No | | |
| | | | 180 C. | | | | | Activation | | |
| Comments | Standard | Standard | Standard | No | | Peroxide | Ebeam | | Peroxide | E-beam |
| | | | | Activation | | Activated | Activated | | Activated | Activated |
| | | | | Step | | in Situ | 50 mGy | | (Heat | 50 mGy |
| | | | | | | | | | activation) | |

Peroxane HX (2,5-Dimethyl-2,5-ditert.butylperoxy)hexane

TABLE 3D

| | Q | R | S | T | U | V | W | X | Y | Z |
|---|---|---|---|---|---|---|---|---|---|---|
| | php | php | php | php | php | Php | php | php | php | php |
| Laromer LR 9007 | | | | | 37.5 | 37.5 | 37.5 | 37.5 | 37.5 | 37.5 |
| (OH = 130) | | | | | | | | | | |
| Desmophen 3223 | | | 37.5 | 37.5 | | | | | | |
| (oh = 35) | | | | | | | | | | |
| Lupranol 4700 | 100 | 100 | 62.5 | 62.5 | 62.5 | 62.5 | 62.5 | 62.5 | 62.5 | 62.5 |
| (oh = 28) | | | | | | | | | | |
| TDI (65/35) | 35 | 35 | 35 | 35 | 35 | 35 | 35 | 35 | | |
| TDI (80/20) | | | | | | | | | 35 | 35 |
| Iso Index | 110 | 110 | 110 | 110 | 110 | 110 | 110 | 110 | 110 | 110 |
| Water | 2.14 | 2.14 | 2.14 | 2.14 | 2.14 | 2.14 | 2.14 | 2.14 | 2.14 | 2.14 |
| Peroxan DC | | | | | | | | | 0.6 | 1 |
| Peroxan BHP | | | | | | | 1 | | | |
| Peroxide | 0 | 0 | 0 | 0 | 0 | 0 | | 0 | | |
| Niax A1 | 0.06 | 0.06 | 0.2 | 0.2 | 0.2 | 0.2 | 0.2 | | | |
| DMEA | 0.06 | 0.06 | 0.06 | 0.06 | 0.06 | 0.06 | 0.06 | 0.06 | 0.06 | 0.06 |
| Stannous Octoate | 0.11 | 0.11 | 0.06 | 0.06 | 0.06 | 0.06 | 0.2 | 0.2 | 0.2 | 0.2 |
| Urea | 0.45 | 0.45 | 0.45 | 0.45 | 0.45 | 0.45 | 0.45 | 0.45 | 0.45 | 0.45 |
| Silicone | 0.8 | 0.8 | 0.1 | 0.1 | 0.1 | 0.1 | 0.1 | 0.4 | 0.4 | 0.4 |
| Mersolat H-40 | 0.4 | 0.4 | 0.4 | 0.4 | 0.4 | 0.4 | 0.4 | 0.4 | 0.4 | 0.4 |
| Density Kg/M3 | 44.1 | 44.1 | 44.8 | 44.8 | 43.5 | 43.5 | 45.8 | 43.5 | 41.3 | 41.3 |
| Compression | 36.6 | 32.88 | 20.46 | 22.51 | 22 | 23.72 | 56.6 | 53.1 | 19.63 | 109.4 |
| Hardness Kpa | | | | | | | | | | |
| (No precycle) | | | | | | | | | | |
| Activation | none | 20 min./ | none | 20 Min/ | none | 20 min. | Peroxide | E beam | none | Peroxide |
| Comments | Standard | 180 C. | | 180 C. | | 180 C. | | Activated | | Activated |
| | | Standard | | | | | | 50 mGy | | 2nd Step |
| | | | | | | | | | | 20 min. |
| | | | | | | | | | | 180 deg |

TABLE 3E

| | AA | BB |
|---|---|---|
| 1,6 DEXA | 100 | 100 |
| PIPA 97/10 | 10 | 10 |
| Desmodur N 100 | 100 | 100 |
| Water | 4.4 | 4.4 |
| Niax A1 | 0.6 | 0.6 |
| NIAX A 30 | 0.6 | 0.6 |
| Peroxan BHP | 0 | 0.5 |
| SiliconeSurfactant | 0.6 | 0.6 |
| EM | 1 | 1 |
| Density Kg/M3 | 66.8 | 74.1 |
| Compression Hardness Kpa | 1.92 | not relevant |
| (ENISO 3386-1) | | |
| Activation | E-beam | Peroxide in |
| | (50 + 32 mGy) | situ |
| Compression Hardness Kpa | | |
| (No precycle) | 104 | 227.4 |

TABLE 3F

| | A1 | B1 |
|---|---|---|
| Desmophen 3223 (oh = 35) | 100 | 97 |
| Laromer LR 8800 (oh = 80) | | 3 |
| TDI (80/20) | 65 | 65.6 |
| Water | 6 | 6 |
| Niax A1 | 0.12 | 0.1 |
| Stannous Octoate | 0.23 | 0.23 |
| Silicone | 0.8 | 0.8 |
| Methylene Chloride | 1 | 1 |
| Without microwave | | |
| Density Kg/M3 | 21.3 | 21 |
| 40% CLD kPa | 3.76 | 3.56 |
| Foam Colour | White | White |
| L*/a*/b* | 86.73/−0.39/−0.78 | 84.72/−0.25/−0.54 |
| With microwave 40 secs at | 800 watts | 800 watts |
| Density Kg/M3 | 19 | 16.5 |
| 40% CLD (kPa) | not measurable | 3.7 |
| Foam intregrity | Crumbled | Intact |
| Foam Colour | Dark brown | Light yellow |
| L*/a*/b* | 64.01/9.28/31.55 | 84.35/−1.89/8.91 |
| Delta E | 40.68 | 9.6 |

TABLE 3G

| | A2 | B2 | C2 | D2 |
|---|---|---|---|---|
| | php | php | Php | php |
| Laromer LR 8986 | 0 | 40 | 40 | 40 |
| Voranol CP 1421 | 50 | 50 | 50 | 50 |
| Lupranol 4700 | 10 | 10 | 10 | 10 |
| Voranol CP 755 | 40 | 0 | 0 | 0 |
| Voranate M 220 | 35 | 35 | 35 | 35 |
| Water | 2.5 | 2.5 | 2.5 | 2.5 |
| Dabco 33 LV | 0.2 | 0.2 | 0.2 | 0.2 |
| Niax A1 | 0.1 | 0.1 | 0.1 | 0.1 |
| Peroxan DC | 0 | 0 | 0 | 2 |
| Stannous Octoate | 0.05 | 0.05 | 0.05 | 0.05 |
| Silicone | 0.5 | 0.5 | 0.5 | 0.1 |
| surfactant | | | | |
| Properties | | | | |
| Density Kg/m3 | 54 | 60 | 60 | 52 |
| Compression | 1.5 | 2.8 | 61.1 | 31.6 |
| Hardness Kpa | | | | |
| (No precycle) | | | | |
| Comments | Standard | Standard | Standard | Peroxide |
| | W/O | With | With | Activated |
| | Acrylate | Acrylate | Acrylate | 20 min. |
| | | | | 180 Deg. C. |
| | | No activation | E-beam | Activation |
| | | | Activated | |

TABLE 3H

| | A3 | B3 |
|---|---|---|
| Laromer LR 9007 | 0 | 20 |
| Prepolymer 30 | 100 | 80 |
| TDI(80/20) | 32.3 | 33.9 |
| Iso Index | 105 | 100 |
| Water | 2.6 | 2.6 |
| Peroxan PK295V-90 | 0 | 0.9 |
| Urea | 0.4 | 0.35 |
| DMEA | 0.06 | 0.06 |
| Stannous Octoate | 0.13 | 0.08 |
| Silicone surfactant | 0.6 | 0.4 |
| Density Kg/m3 | 37.7 | 37.5 |
| Compression Hardness | 5.41 | 8.68 |
| Kpa (ENISO 3386-1) | | |

TABLE 3I

| | A4 | B4 | C4 | D4 | E4 |
|---|---|---|---|---|---|
| Laromer LR 9007 | 0 | 30 | 0 | 15 | 30 |
| Desmophen 3223 | 50 | 20 | 15 | 0 | 0 |
| PIPA 97/10 | 50 | 50 | 85 | 85 | 70 |
| TDI(80/20) | 50.2 | 51.0 | 51.1 | 49.7 | 51.5 |
| Iso Index | 105 | 95 | 102 | 95 | 95 |
| Water | 3.86 | 3.86 | 3.0 | 3.0 | 3.0 |
| Peroxan PK295V-90 | 0 | 1.0 | 0 | 0 | 0 |
| Sorbitol | 0.6 | 0.6 | 0.8 | 0.8 | 0.8 |
| Stannous Octoate | 0.05 | 0.05 | 0.05 | 0.05 | 0.05 |
| Low activity Silicone | 0.3 | 0.3 | 0.3 | 0.3 | 0.3 |
| surfactant | | | | | |
| Silicone surfactant | 0 | 0.5 | 0 | 0 | 0 |
| Diethanolamine | 1.0 | 1.0 | 1.0 | 1.0 | 1.0 |
| urea | 0.4 | 0.4 | 0.4 | 0.4 | 0.4 |
| Density Kg/m3 | 26.9 | 25.1 | 24.5 | 27.6 | 27.8 |
| Compression Hardness | 3.88 | 34.82 | 3.47 | 4.78 | 5.44 |
| Kpa (ENISO 3386-1) | | | | | |
| Compression Hardness | — | — | — | 6.71 | 10.91 |
| Kpa (ENISO 3386-1) | | | | | |
| E-Beam activated 32 mGy | | | | | |

Substance Explanation
Acrylates
Laromer 9007: oligoether acrylate, mol wt approx 600, acrylate functionality about 4 db/mole, made by BASF AG
Laromer 8800: Polyhydroxyacrylate, mol wt approx 900, acrylate functionality about 3.5 db/mole made by BASF AG
1,6 dexa: 1,6-bis(3acryloyl-2-hydroxypropoxy)hexane with 2 db/mole, manufactured by Mitsuya Boeki, Osaka, Japan)
Laromer 8986: Aromatic epoxy diacrylate of mol wt 650, acrylate functionality of about 2.5 db/mole, made by BASF AG
Polyols/Carriers
PIPA 97/10: is a 10% dispersion of a polyisocyanate polyaddition (PIPA) adduct in an ethylene oxide tipped 4800 mol wt polyether polyol., made by Shell Chemicals—a polymer modified polyol
Dispersant EM: a non ionic emulsifier made by Rheinchemie AG.
Desmophen 3223: Reactive polyether polyol with ethylene oxide tip, mol wt approx 5000 made by Bayer AG
Lupranol 4700: 40% solid styrene/acrylonitile copolymer polyol manufactured by BASF based on an essentially non EO capped polyether polyol—a polymer modified polyol
Voranol CP 755: Non reactive polyether polyol of mol wt 700 made by Dow Chemical Corp
Voranol CP 1421: reactive high ethylene oxide containing polyether polyol, mol wt approx 5000, made by Dow Chemical Corp
Prepolymer 30

Production of a Prepolymer by the Batch Process.

96.24% polyether polyol [DESMOPHEN 20WB56 (Bayer)], hydroxyl number: 56, viscosity: approx. 700 mPa·s at 20° C.]3.75% diisocyanatotoluene 80/20 (TDI 80/20) 0.00385% dibutyltin dilaurate (DBTL)

The polyether polyol is placed in a mixing vessel at room temperature and dibutyltin dilaurate is then added whilst stirring. The diisocyanatotoluene is slowly stirred into this mixture.

After about 24 h the resulting prepolymer has a viscosity of approx. 30,000 mPa·s at 25° C. and a hydroxyl number of 30.

Isocyanates

TDI (80/20):Tolylene diisocyanate with ratio of isomers 2,4 to 2/6 of 80%/20%

TDI (65/35):Tolylene diisocyanate with ratio of isomers 2,4 to 2,6 of 65%/35%

Desmodur 100: is an aliphatic isocyanate (NCO content 22%) made by Bayer AG

Voranate M 220: Polymeric MDI made by Dow Chemical Corp

Peroxides

PEROXAN PK295V-90: 1,1 (Di(tert-butylperoxy)-3,3,5-trimethylcyclohexane, 90% solution in OMS (Odourless Mineral Spirits) or isododecane, has a half life of 13 mins at 128° C. from Pergan (Germany)

Perozane HX (2,5-dimethyl-2,5-ditert.butylperoxy)hexane

Perozan BHP70: 70% t-butyl peroxide in water, has a half life of 1 min at 222° C.

Peroxan DC: dicumyl peroxide, has a half life of 1 minute at 172° C. made by Pergan Germany.

Amine Catalysts

Niax A1: Air Products Inc (USA)

DMEA: dimethylethanolamine

Dabco 33 LV: triethylenediamine made by Air Products

Silicone Surfactants

Examples of silicone surfactants (for standard foam formulations) are Silbyk 9001 Or 9025 from Byk Chemie or Tegostab BF 2370 or B 8002 from Goldschmidt.

Examples of low activity silicone surfactants are Silbyk 9705 or 9710 from Byk Chemie, Tegostab B 8681 from Goldschmidt or L-2100 from GE advanced materials. These products are used for high resilience foams. They differ from the silicone surfactants described above by the fact that they are less active due to lower molecular polysiloxane and polyoxyalkylene chains.

Mersolat H-40

Sodium alkane sulfonate from Lanxess (Germany)

Explanation of the Tables

Table 3A (Corresponds to Above Table 1)

Examples A & B show equivalent formulations, both containing an acrylate. Example B however is activated in situ by the peroxide present resulting in a large increase in foam hardness

Table 3B

Contains a Series of Equivalent Formulations.

Example C is a formulation with zero acrylate, by adding acrylate (example D) but no energy (E beam) or radical (Peroxide) to activate the acrylate, the difference in foam hardness between C & D is minimal. In example E, the acrylate is activated by E Beam and a small hardness increase is seen, in Example F the acrylate is activated by a peroxide, there is a large increase in foam hardness.

Table 3C

Once Again a Series of Equivalent Formulations

Example G, H & I are not examples of the invention but separate out the effect on foam hardness of different combinations of polyols used later in the table.

Examples J & K have acrylate present, but the acrylate in J is not activated (by either E beam or a peroxide) and shows very little change in foam hardness. Example K is activated by applying heat to the finished foam, there is a very small increase in hardness.

Example M is equivalent to J, but is E beam activated, Example L (also similar to J) is in situ activated with a peroxide.

Examples N, O & P are activated with different peroxides with different activation temperatures. In example N the peroxide is chosen so that there is no activation of the acrylate during the foam reaction. Example O is activated by the use of peroxide with subsequent heat and the foam hardness has increased. In example P, peroxide is used and the foam is activated by E beam, the foam hardness once again is increased dramatically.

Table 3D

The table is similar in logic to that of Table 3C, except a different acrylate is used.

Examples Y & Z show if the exotherm of the foam forming reaction is insufficient, of the exothermy is dissipated quickly, the peroxide will fail to react (Y). However the finished foam may be heated, the acrylate will be activated and the foam hardness will be seen to increase.

Table 3E

Examples show the effect of E beam and peroxide activation on formulations using an aliphatic isocyanate.

Table 3F (this corresponds to above Table 2)

Most polyols contain small amounts of peroxide, and during the foam formation reaction further very small amounts of peroxide are produced. In formulations with high exotherms, these trace peroxides may lead to discolouration (scorching) of the foam. In extreme circumstances the foam, shortly after manufacture, can auto ignite. The conditions of high exotherm formulations made on hot humid days with raw materials containing relatively high levels of impurities can lead to this auto ignition. The foams in TABLE 3F are made with very high water levels (6php) to produce very high exotherm, the foam is the immediately put into a microwave to accentuate this discolouration, and also prevent the exotherm dissipating.

Table 3G

This shows B2, C2 and D2 as examples of the invention. A2 is not an example of the invention as it is a standard flexible foam formulation. B2 shows the effect of an polyhydroxyacrylate compound added to the formulation A2. The small increase in hardness is the typical effect when a relatively low molecular weight high functionality polyol is been added to the formulation A1.

C2 shows one method of activation of the acrylate (E Beam) The hardness is increased here by a factor of about 40.

D2 shows peroxide activation of the acrylate as a second step (not during foaming). This was due to the exotherm being too quickly dissipated in the laboratory sized sample, so second stage activation (via oven heating) was carried out to approximate the effect obtained on an industrial scale basis.

Table 3H demonstrates that the concept also works with prepolymers as disclosed in copending patent application (PCT/EP 2005/005314).

Example A3 is not an example of the invention. B3 shows that the use of some Laromer in the formulation increases the loadbearing of the foam by peroxide activation.

Table 3I demonstrates that the invention also works in High Resilience technology raw materials with one isocyanate and a polymer modified polyol. The low activity silicone surfactant is a known high resilience surfactant. Formulation A4 is not an example of the invention and gives low density soft foam. With an hydroxyacrylate and peroxide activation the hardness is increased by a factor around 10. Formulation C4 is not an example of the invention. Formulations D4 and E4 show that significant hardness increase is obtainable through E-beam activation of the double bonds.

1-36. (canceled)

37: A method of manufacturing polyurethane foam wherein at least one multi-functional isocyanate, at least one polyol being wholly or predominantly a polyether polyol having a molecular weight greater than 1500 and foam-forming ingredients, undergo a polyaddition and foam-forming reaction in the presence of at least one reactive double bond component to produce a foamed PU body, wherein the at least one multifunctional isocyanate substantially does not comprise or include MDI, and the foamed PU body is subjected to radical-initiated cross-linking with the reactive double bond component.

38: A method according to claim 37 wherein the foam is formulated as an HR foam.

39: A method according to claim 37 wherein the foam is formulated as a non-HR foam.

40: A method according to claim 37 wherein the polyol comprises or includes at least one polymer modified polyol.

41: A method according to claim 37 wherein at least one radical-forming agent, preferably an organic peroxide, is also added to the mixture of basic components.

42: A method of manufacturing polyurethane foam wherein at least one multi-functional isocyanate, at least one polyol being wholly or predominantly a polyether polyol having a molecular weight greater than 1500 and foam-forming ingredients, undergo a polyaddition and foam-forming reaction in the presence of at least one reactive double bond component to produce a foamed PU body, wherein the foam is not HR foam, and the foamed PU body is subjected to radical-initiated cross-linking with the reactive double bond component.

43: A method according to claim 42 wherein the polyol comprises or includes at least one polymer modified polyol.

44: A method according to claim 42 wherein at least one radical-forming agent, preferably an organic peroxide, is also added to the mixture of basic components.

45: A method of manufacturing polyurethane foam wherein at least one multi-functional isocyanate, at least one polyol and foam-forming ingredients, undergo a polyaddition and foam-forming reaction in the presence of at least one reactive double bond component to produce a foamed PU body, wherein the polyol comprises or includes at least one polymer modified polyol, and the foamed PU body is subjected to radical-initiated cross-linking with the reactive double bond component.

46: A method according to claim 45 wherein the polyol is wholly or predominantly a polyether polyol.

47: A method according to claim 45 wherein the polyol has a molecular weight greater than 1500.

48: A method according to claim 45 wherein the foam is formulated as an HR foam.

49: A method according to claim 45 wherein the foam is formulated as a non-HR foam.

50: A method according to claim 45 wherein the at least one multifunctional isocyanate substantially does not comprise or include MDI.

51: A method according to claim 45 wherein at least one radical-forming agent, preferably an organic peroxide, is also added to the mixture of basic components.

52: A method of manufacturing polyurethane foam wherein basic components comprising at least one multi-functional isocyanate, at least one polyol and foam-forming ingredients, undergo a polyaddition and foam-forming reaction in the presence of at least one reactive double bond component to produce a stable open-celled substantially discoloration-free foamed PU body, characterised in that the open-celled substantially discoloration-free foamed PU body is subjected to radical-initiated cross-linking of the reactive double bond component to give a compression hardness at least 10% greater than the comparable hardness of the stable open celled substantially discoloration-free foamed PU body formed using comparable said basic components without addition of the said double bond component.

53: A method of manufacturing polyurethane foam wherein basic components comprising at least one multi-functional isocyanate, at least one polyol and foam-forming ingredients including water but substantially in the absence of any volatile foam forming ingredient, undergo a polyaddition and foam-forming reaction in the presence of at least one reactive double bond component to produce a stable open-celled substantially discoloration-free foamed PU body, characterised in that the open-celled substantially discoloration-free foamed PU body is subjected to radical-initiated cross linking of the reactive double bond component, and wherein the double bond component is used at 0.1 to 10 parts, preferably 0.1-5 parts, particularly approximately 3 parts, and the water is used at greater than 4 parts.

54: A method according to claim 37, wherein the basic components are used in a concentration and/or quantity, which produces an exothermy sufficient for radical formation.

55: A method according to claim 37, wherein the concentration of the component having the reactive double bonds is varied or adjusted in order to control the intensity of the reaction and/or the speed and/or the extent of the radical cross-linking.

56: A method according to claim 37, wherein the concentration of the component having the reactive double bonds is varied or adjusted in order to control the hardness and/or load-bearing capacity of the foam produced.

57: A method according to claim 37, wherein the concentration of the component having the reactive double bonds is varied or adjusted in order to prevent the oxidative degradation of the foam produced.

58: A method according to claim 41, wherein the concentration of component having the reactive double bonds is adjusted to the concentration of the radical-forming agent added, and/or at least one radical-trapping substance, in particular at least one antioxidant, is added to the mixture of basic components.

59: A method according to claim 37, wherein the reaction components:
a) up to 99 php (relative to a)+b)) polyether and/or polyester polyols with OH groups having a functionality of preferably 2 to 5;
b) up to 99 php polymers and/or monomers having reactive double bonds, in particular on an acrylate or methacrylate basis;
c) polyisocyanate with an NCO-functionality of preferably 2 to 5, in a quantity calculated for an index of 50 to 120, preferably 70 to 130, in particular of 85 to 120;
d) 0.5 to 20 php, in particular 2 to 12 php water as blowing agent;
e) where necessary 0.05 to 5 php of at least one reaction initiator or radical-forming agent, preferably of an organic peroxide;
f) any catalysts;
g) any other auxiliary agents are mixed with one another and are made to react.

60: A method according to claim 37 wherein the reactive double bond component contains hydroxyl groups or other NCO active groups, in particular acrylate or methacrylate polymers containing hydroxyl groups.

61. A method according to claim 37 wherein at least part of the polyol and/or the double bond component are used as a prepolymer formed by pre-reaction with a multifunctional isocyanate.

62: A method according to claim 37 wherein at least part of the polyol is a polymer-modified polyol.

63: A method according to claim 41 wherein the organic peroxide has a half-life ranging from approx. 15 minutes to approx. 5 seconds within a temperature range of 120-250° C.

64: A method according to claim 44 wherein the organic peroxide has a half-life ranging from approx. 15 minutes to approx. 5 seconds within a temperature range of 120-250° C.

65: A method according to claim 51 wherein the organic peroxide has a half-life ranging from approx. 15 minutes to approx. 5 seconds within a temperature range of 120-250° C.

66: A method according to claim 41 wherein an organic peroxide is included as reaction initiator selected from the group of hydroperoxides, dialkylperoxides, diacylperoxides, peracids, ketoneperoxides and epidioxides.

67: A method according to claim 44 wherein an organic peroxide is included as reaction initiator selected from the group of hydroperoxides, dialkylperoxides, diacylperoxides, peracids, ketoneperoxides and epidioxides.

68: A method according to claim 51 wherein an organic peroxide is included as reaction initiator selected from the group of hydroperoxides, dialkylperoxides, diacylperoxides, peracids, ketoneperoxides and epidioxides.

69: A method according to claim 37 wherein the foamed PU body is subjected to radical initiated cross-linking under the influence of ionizing radiation.

70: A method according to claim 69 wherein the ionizing radiation is e-beam radiation.

71: A method according to claim 37, wherein carbon dioxide gas is used as additional blowing agent.

72: A method according to claim 37, wherein the foaming is performed at pressures greater than or less than atmospheric pressure.

73: A method according to claim 37, wherein the basic components are fed in individually, mixed in a mixer or mixing head and then foamed, preferably with simultaneous forming.

74: A method according to claim 37 for the manufacture of polyurethane foams on an industrial scale, in particular for the industrial manufacture of PU foam slab stocks or moulded parts.

75: High-load bearing polyurethane foam produced from polyol, polyisocyanate and double bond components, wherein it has an homogeneous matrix produced by the simultaneous occurrence of polyaddition and radically induced cross-linking reaction of the double bond components.

76: Polyurethane foam according to claim 75, wherein for a given density and cell count it has an at least 10%, preferably at least 15% greater hardness and/or load-bearing capacity than conventional foams of comparable formulation.

77: Polyurethane foam according to claim 75, wherein it has at least one of the following characteristics:
a gross density of 5 to 120 kg/m3;
a cell count of 10 to 120 ppi;
a compression hardness of at least 5 kPa, preferably at least 15 kPa and in particular at least 20 kPa, measured according to EN ISO 3386-1, at 40% deformation;
at least predominantly open cells.

78: Polyurethane foam obtainable in a method according to claim 37.

79: A method of using a polyurethane foam according to claim 71 as composite material, for packaging applications, for thermal and/or sound insulation, for the manufacture of displays, filters, seating and beds, for many different industrial applications and/or transport purposes, in particular for applications in the motor vehicle sector and in building and construction.

80: A method of manufacturing a polyurethane foam, wherein at least one multi-functional polyisocyanate, at least one polyol and foam-forming ingredients, undergo a polyaddition and foam-forming reaction in the presence of a reactive double bond component to produce a foamed PU body, and wherein the PU body is subjected to radical-initiated cross-linking with the reactive double bond component which occurs in a parallel with the said polyaddition and foam-forming reactions.

81: A method of manufacturing polyurethane foam wherein at least one multi-functional isocyanate, polyol being exclusively or predominantly polyether polyol having a molecular weight greater than 1500 and foam-forming ingredients, undergo a polyaddition and foam-forming reaction in the presence of at least one reactive double bond component to produce a foamed PU body, wherein the at least one multifunctional isocyanate substantially does not comprise or include MDI, and the foamed PU body is subjected to radical-initiated cross-linking with the reactive double bond component.

82: A method of manufacturing polyurethane foam wherein at least one multi-functional isocyanate, at least one polyol being exclusively or predominantly polyether polyol having a molecular weight greater than 1500 and foam-forming ingredients, undergo a polyaddition and foam-forming reaction in the presence of at least one reactive double bond component to produce a foamed PU body, wherein the polyol comprises or includes at least one polymer modified polyol, and the foamed PU body is subjected to radical-initiated cross-linking with the reactive double bond component under the influence of ionizing radiation.

83: A method of manufacturing polyurethane form wherein at least one multi-functional isocyanate, at least one polyol being exclusively or predominantly polyether polyol having a molecular weight greater than 1500 and foam-forming ingredients, undergo a polyaddition and foam-forming reaction in the presence of at least one reactive double bond component to produce a foamed PU body, wherein the foam is formulated as a non-HR foam, and the foamed PU body is subjected to radical-initiated cross-linking with the reactive double bond component under the influence of ionizing radiation.
